(19) United States
(12) Patent Application Publication
(10) Pub. No.: US 2015/0015589 A1
(43) Pub. Date: Jan. 15, 2015

(54) DEVICE AND METHOD OF POWER MANAGEMENT FOR GRAPHIC PROCESSING UNIT

(71) Applicant: POSTECH ACADEMY - INDUSTRY FOUNDATION, Pohang-si (KR)

(72) Inventors: Ki Seok CHUNG, Pohang-si (KR); Dae Cheol YOU, Ansan-si (KR)

(21) Appl. No.: 14/501,817

(22) Filed: Sep. 30, 2014

(30) Foreign Application Priority Data
Oct. 2, 2012 (KR) 10-2013-0117743

(51) Int. Cl. G06F 1/32; G06T 1/20

(52) U.S. Cl. CPC G06F 1/324; G06F 1/3206; G06T 1/20
USPC 345/501

(57) ABSTRACT

Disclosed are a graphic processing unit, a power management device, and a power management method for the same. The power management device comprises a target frame number determining part configured to determine a target frame number which the GPU is required to process in a time period; a processed frame number determining part configured to determine a processed frame number processed by the GPU in a previous time period; and an operating frequency adjusting part configured to calculate a loss frame number based on the target frame number and the process frame number, and adjust an operating frequency of the GPU based on the loss frame number.

### CLAIM FOR PRIORITY

This application claims priority to Korean Patent Application No. 10-2013-0117743 filed on Oct. 2, 2013 in the Korean Intellectual Property Office (KIPO), the entire contents of which are hereby incorporated by references.

### BACKGROUND

1. Technical Field

Example embodiments of the present invention relate to power management of a graphic processing unit (GPU), and more specifically to a technique for controlling power consumption of a graphic processing unit based on a dynamic voltage and frequency scaling (DVFS) technique, which can efficiently manage power consumption of GPU by dynamically controlling operating frequency of the GPU so as to satisfy a target frames per second (FPS) and to maintain Quality of Service (QoS).

2. Related Art

Recently, an embedded graphic processing unit processes a large portion of computation needed for a system on chip (SoC) as a mobile terminal apparatus provides higher quality graphics. Also, the GPU is being evolved as a streaming multi-processor constituting a heterogeneous system with a general purpose processor beyond a simple graphic accelerator.

Computational logics of the conventional GPU, which were divided into a vertex processor and a fragment processor, have been integrated into a single shader processor. Also, an interconnect interface connecting an internal memory of the GPU and an internal memory of the central processing unit (CPU) which is a general purpose processor has been introduced. Thus, a target application program of the GPU is not restricted to only a graphic application program, and accordingly the GPU is designed for general parallel operations.

Actually, a GPU used for a desktop platform supports general purpose parallel programming frameworks such as a Compute Unified Device Architecture (CUDA) and an Open Computing Language (OpenCL), and this trend is also being applied to a mobile GPU which is used for an embedded device.

However, a high performance GPU has a high power consumption rate. In order to manage power consumption of the GPU, high-level power management techniques such as a dynamic voltage and frequency scaling (DVFS) should be applied. Since it is not necessary that the GPU always operates at its best performance, for efficient power management of the GPU, a power management integrated circuit (PMIC) of the SoC can provide multi-level operating frequencies to the GPU.

Although a GPU to which a hardware-level DVFS technique is applied can be used for some applications, even in these cases, there may be a problem that an implementation depends upon a specific power management IC. Also, current operating systems (OS) do not provide a power management interface for a GPU as a computational device. This makes it difficult that a dynamic voltage and frequency control which is widely used for the conventional processor power management is applied. That is, since a GPU is a simple input/output (IO) device in an aspect from the Operating system, the power management interface which can be utilized for the GPU is restricted to a simple suspend/resume interface which is applied to an I/O device such as a hard disc.

In order to apply such the DVFS technique to the GPU, the method, in which voltage and frequency for the GPU is dynamically controlled according to utilization ratios of processor cores of the GPU, is available. However, since the number of frames which are processed in a given period by the GPU may have no linear relationship with the utilization ratios of the processor cores of the GPU, the above-described method is not suitable for a case in which the GPU should achieve a processing capability of constant frames per second.

### SUMMARY

Accordingly, example embodiments of the present invention are provided to substantially obviate one or more problems due to limitations and disadvantages of the related art.

Example embodiments of the present invention provide a power management device and a method for dynamically controlling operating voltage and frequency of a graphic processing unit (GPU) by analyzing frames per second (FPS) which can be processed by the GPU in real time so that the GPU can achieve a constant target FPS.

Also, example embodiments of the present invention provide a graphic processing unit to which the above-described power management device and method are applied.

In some example embodiments, a power management device performing power management of a graphic processing unit (GPU), the device may comprise a target frame number determining part configured to determine a target frame number which the GPU is required to process in a time period; a processed frame number determining part configured to determine a processed frame number processed by the GPU in a previous time period; and an operating frequency adjusting part configured to calculate a loss frame number based on the target frame number and the processed frame number, and adjust an operating frequency of the GPU based on the loss frame number.

Here, the processed frame number determining part may determine the processed frame number based on a number of interrupts processed in a frame buffer driver of the GPU.

Here, the operating frequency may be applied to a current time period or a next time period.

Here, the operating frequency adjusting part may control a power management module of an operating system (OS) to adjust the operating frequency of the GPU so that a number of frames processed in a current time period approaches the target frame number.

Here, when the loss frame number is larger than a predetermined threshold value, the operating frequency of a current time period may be set to a higher value than an operating frequency of the previous time period.

Here, when the loss frame number is equal to a predetermined threshold value, the operating frequency of a current time period may be set to a same value with an operating frequency of the previous time period.

Here, when the loss frame number is smaller than a predetermined threshold value, the operating frequency of a current time period may be set to a lower value than an operating frequency of the previous time period.

Here, when the processed frame number of the previous time period is smaller than a predetermined number and a utilization ratio of a processor core of the GPU is lower than a predefined level, the operating frequency of a current time period may be set to a predefined minimum value.

In other example embodiments, A method for performing power management of a graphic processing unit (GPU), the method may comprise determining a target frame number which the GPU is required to process in a time period; determining a processed frame number processed by the GPU in a previous time period; and calculating a loss frame number of the previous time period based on the target frame number and the processed frame number, and adjusting an operating frequency of the GPU based on the loss frame number.

Here, in the determining the processed frame number, the processed frame number may be determined based on a number of interrupts processed in a frame buffer driver of the GPU.

Here, the operating frequency may be applied to a current time period or a next time period.

Here, in the adjusting the operating frequency of the GPU, the operating frequency may be adjusted by controlling a power management module of an operating system (OS) so that a number of frames processed in a current time period approaches the target frame number.

Here, when the loss frame number is larger than a predetermined threshold value, the operating frequency of a current time period may be set to a higher value than an operating frequency of the previous time period.

Here, when the loss frame number is equal to a predetermined threshold value, the operating frequency of a current time period may be set to a same value with an operating frequency of the previous time period.

Here, when the loss frame number is smaller than a predetermined threshold value, the operating frequency of a current time period may be set to a lower value than an operating frequency of the previous time period.

Here, when the processed frame number of the previous time period is smaller than a predetermined number and a utilization ratio of a processor core of the GPU is lower than a predefined level, the operating frequency of a current time period may be set to a predefined minimum value.

In other example embodiments, a graphic processing unit having a power management function, the graphic processing unit may comprise a frame processing information providing part configured to provide information on a processed frame number in a time period; an operating frequency information receiving part configured to receive information on an operating frequency determined based on the processed frame number; and an operating frequency controlling part configured to control a power management module of an operating system (OS) based on the information on the operating frequency so as to adjust the operating frequency.

Here, the processed frame number may be determined based on a number of interrupts processed in a frame buffer driver of the GPU.

Here, the operating frequency may be applied to a current time period or a next time period.

Here, the operating frequency controlling part may control the operating frequency based on a loss frame number and a predetermined threshold value.

According to the power management device, method, and the graphic processing unit of the present invention, power consumption of the graphic processing unit can be efficiently managed through a dynamic voltage and frequency scaling (DVFS) technique with maintaining a target QoS.

### BRIEF DESCRIPTION OF DRAWINGS

Example embodiments of the present invention will become more apparent by describing in detail example embodiments of the present invention with reference to the accompanying drawings, in which:

FIG. 1 is a block diagram to explain a relation between a graphic processing unit 100, a power management device 200, and an operating system 300 according to an example embodiment of the present invention;

FIG. 2 is a block diagram to explain a power management device and its components for a GPU according to an example embodiment of the present invention;

FIG. 3 is a block diagram to explain a method for determining a processed frame number based on the number of generated interrupts in a power management device according to an example embodiment of the present invention;

FIG. 4 is a flow chart to explain a power management method for a graphic processing unit according to an example embodiment of the present invention;

FIG. 5 is a block diagram to explain a graphic processing unit having a power management function according to an example embodiment of the present invention and its components; and

FIG. 6 is a block diagram to explain a method for providing information on a processed frame number based on the number of generated interrupts in a graphic processing unit according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an, idealized or overly formal sense unless expressly so defined herein.

The terminologies which are used in the present specification may be described as follows.

A dynamic voltage scaling (DVS) technique is one of power management techniques which can be used for a computer system. In the DVS technique, a voltage applied to a component of a target device is dynamically increased or decreased whereby power consumption of the component can be controlled. The DVS technique may decrease an operating voltage in order to reduce power consumption of a mobile device such as a lap-top computer which uses a battery with a limited energy capacity. Also, when a high performance is needed, the operating voltage may be increased in order to achieve high performance of the computer system. A modern microprocessor uses the DVS with a clock gating or a dynamic frequency scaling (DFS) for both power consumption management and performance enhancement.

The DFS or a CPU throttling technique is one of power management techniques used for a computer system. They control power consumption of the computer system by dynamically increasing or decreasing operating frequencies of components of the computer system. The DFS technique decreases operating frequencies in order to reduce power consumption of a laptop computer or a mobile device using a battery having a limited energy capacity or in order to reduce a cooling cost or a noise level when a work load of the computer system is low. On the contrary, it increases operating frequencies in order to increase system performance without regard to power consumption. The representative examples of this technique include a Turbo Boost technology of Intel and a Demand Based Switching (DBS) technology. As an extreme case, if a system operation is determined to be not required for a predefined duration, the operating frequency to be provided may be cut (i.e. the clock gating).

The technique into which the DVS and the DFS are combined may be referred to as a Dynamic Voltage and Frequency Scaling (DVFS).

A frame buffer is a hardware component used for the OS to represent a graphic. Specifically, it may be a memory device which temporally stores image information to be displayed in a raster method on a screen of a display device. That is, a graphic card for a personal computer and a LCD controller for Strong ARM system may comprise the frame buffer. Also, a device driver which can control the frame buffer in a user-level application may be referred to as a frame buffer driver. A standardized interface (e.g. Application Programming Interface) may be provided to an application program developer so as to make it possible to develop an application program through the interface.

For example, a graphic processor may receive a list of objects to be displayed from a central processing unit, represent the objects, and record the represented objects in the frame buffer. Each memory unit of the frame buffer may correspond to a pixel of the screen. That is, since each memory unit is configured to store information on an on/off state or a color of the corresponding pixel on the screen, contents written to the frame buffer may be directly displayed on the screen. Generally, the frame buffer may be configured as a separate memory device with relatively higher performance as compared to a main memory device of the system.

An interrupt is an event for the CPU to immediately check a system status and respond to a change of the system status when an exceptional case occurs during execution of normal routines. When the interrupt is generated, an interrupt service routine (ISR) corresponding to the generated interrupt is called, and the exceptional case is resolved by the execution of the corresponding ISR. Then, the systems status is returned to the status before the interrupt.

The cause of the interrupt may include a case of an unexpected power failure, a case of a hardware problem occurring in the computer system (i.e. a machine check interrupt), a case of an intentional program halt originated by an operator or a timer (i.e. an external interrupt), a case of termination of Input/Output (I/O) or an error of I/O (i.e. an I/O interrupt), a case when an illegal access to protected memory regions occurs or when an illegal instruction is called (i.e. a program check interrupt), etc.

Hereinafter, preferred example embodiments according to the present invention will be explained in detail by referring to accompanying figures.

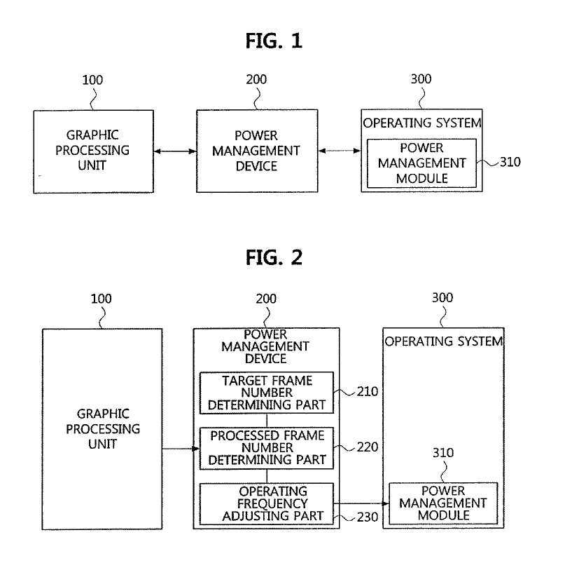

FIG. 1 is a block diagram to explain a relation between a graphic processing unit 100, a power management device 200, and an operating system 300 according to an example embodiment of the present invention.

Referring to FIG. 1, a power management module 310 of the operating system (OS) 300 for power management of the graphic processing unit (GPU) 100 may calculate, based on a periodicity with which it operates and a FPS configured by a user, a target frame number (i.e. the number of frames which should be processed in a single time period) which should be achieved for each time period. For example, if the power management module is configured to operate every 100 milliseconds and the user-configured FPS is 30, the target frame number may become 3.

The power management device 200 may calculate the number of frames processed by the GPU 100 for each time period, compare the processed frame number with the target frame number, and manage power of the GPU 100 by controlling operating frequency through the power management module 310 of the OS 300.

The equation of general power consumption is represented as follows.

P=αCV²·f [Equation 1]
α: switching activity factor
C: electrostatic capacitance of a circuit
V: supplied voltage
f: operating frequency

That is, since the power consumption is proportional to a square of voltage (V²), the power consumption can be controlled by controlling the supplied voltage (V). Also, since the power consumption is proportional to the operating frequency (f), the power consumption can also be controlled by controlling the operating frequency (f). Each circuit has a certain amount of capacitance (C) and it represents how much time is required for a given current to generate a given voltage change. In order to toggle the voltage, charging and discharging of electric charges are necessary. Also, since a current is related to a voltage, the time is also related to the voltage applied to the circuit. The capacitance of the circuit can be charged or discharged faster by applying a higher voltage to the circuit. This makes a faster operation and a higher operating frequency of the circuit possible.

The power management device 200 may be embodied as a computer program product including program codes. These program codes can be executed by the GPU 100, a processor of a computing device comprising the GPU 100, or a separate processor.

FIG. 2 is a block diagram to explain a power management device and its components for a GPU according to an example embodiment of the present invention.

Referring to FIG. 2, the power management device 200 for the GPU 100 may comprise a target frame number determining part 210 configured to determine a target frame number which should be processed for each time period, a processed frame number determining part 220 configured to determine the number of frames processed by the GPU 100 in the previous time period, and an operating frequency adjusting part 230 configured to calculate a loss frame number based on the target frame number and the processed frame number and adjust an operating frequency of the GPU 100 based on the loss frame number.

The operating frequency adjusting part 230 may adjust the operating frequency of the GPU 100 based on the target frame number and the processed frame number for each time period. The loss frame number may be a difference between the target frame number and the processed frame number, and may be used for the operating frequency adjustment. For example, if the loss frame number is less than 0, it can be known that frames more than the target frame number were processed in the previous time period. In this case, the power management module 310 of the OS may control (that is, lower) the operating frequency of the GPU 100 so as to meet the target frame number.

The target frame number and the processed frame number can be determined respectively by the target frame number determining part 210 and the processed frame number determining part 220, and transferred to the operating frequency adjusting part 230.

The operating frequency may be applied to a current time period or a next time period. Also, the operating time frequency adjusting part 230 may adjust the operating frequency by controlling the power management module 310 of the OS 300 so that the processed frame number for the current time period approaches the target frame number.

The operating frequency adjusted based on the loss frame number of the previous time period or the processed frame number may be directly applied to the current time period of the GPU 100. Alternatively, the adjusted operating frequency may be applied to the next time period. For example, if the loss frame number of the previous time period is large, the operating frequency of the current time period may be increased proportionally to the loss frame number. Alternatively, the operating frequency may be adjusted based on a moving average of the loss frame number. Alternatively, the operating frequency may be adjusted by estimating a loss frame number of the current time period or a next time period on the basis of a regression analysis on the loss frame numbers of several previous time periods.

If the loss frame number is larger than a predetermined threshold value, the operating frequency of the current time period may be controlled to be higher than the operating frequency of the previous time period. Also, if the loss frame number is identical to the predetermined threshold value, the operating frequency may be maintained. On the contrary, if the loss frame number is smaller than the predetermined threshold value, the operating frequency of the current time period may be controlled to be lower than the operating frequency of the previous time period.

For example, when the predetermined threshold value is configured to be 0, if the loss frame number of the previous time period is larger than 0, the power management device 200 may control the power management module 310 of the OS 300 to select a higher operating frequency for the GPU 100 than the operating frequency of the previous time period. In this case, a change amount of the operating frequency may be selected according to the processed frame number or the loss frame number of the previous time period.

The predetermined threshold value can be determined according to a power management policy of the GPU 100. For example, a lower threshold value may generally realize lower loss frame numbers so that a stable frame processing of the GPU 100 can be achieved. However, efficiency of power consumption may be reduced. On the contrary, a higher threshold value may generally realize higher power consumption efficiency. However, the stable frame processing of the GPU 100 can be sacrificed. That is, the predetermined threshold value can be determined based on a relation between frame processing stability and power consumption efficiency.

When the loss frame number of the previous time period is identical to the threshold value, the power management device 200 may control the power management module 310 of the OS 300 to maintain the operating frequency. When the loss frame number of the previous time period is smaller than the threshold value, the power management device 200 may control the power management module 310 of the OS 300 to select an operating frequency lower than the operating frequency of the previous time period. In this case, a change amount of the operating frequency may be selected according to the processed frame number or the loss frame number of the previous time period.

If the process frame number of the previous time period is equal to or smaller than a predetermined number and utilization ratios of processor cores of the GPU 100 are lower than a predetermined level, the operating frequency of the previous time period may be adjusted to be a predetermined minimum value.

For example, when the processed frame number of the previous time period is 0 and the utilization ratios of the processor cores of the GPU 100 are lowered below the predetermined level, it can be assumed that no tasks are assigned to the GPU 100. In this case, the power management device 200 may control the power management module 310 of the OS 300 to select the lowest operating frequency so as to reduce power consumption of the GPU 100.

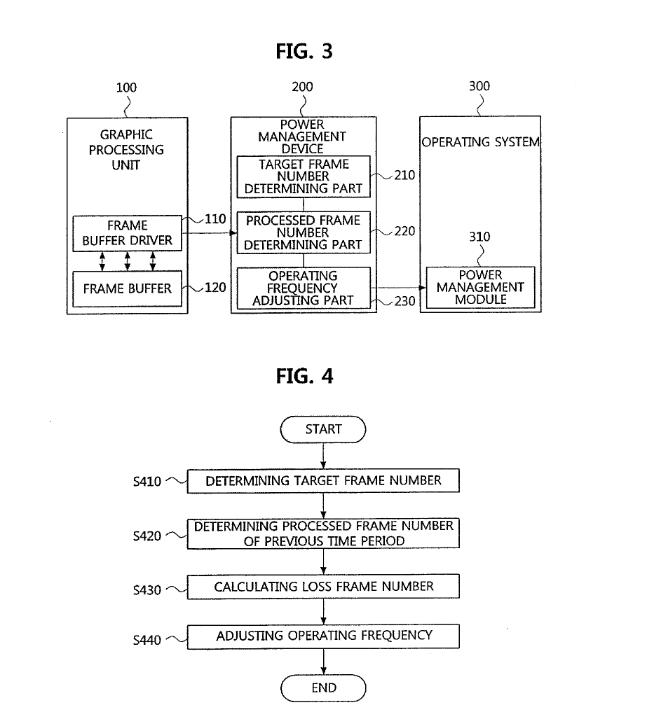

FIG. 3 is a block diagram to explain a method for determining a processed frame number based on the number of generated interrupts in a power management device according to an example embodiment of the present invention.

Referring to FIG. 3, the processed frame number determining part 220 may determine the processed frame number based on the interrupts processed in a frame buffer driver 110 of the GPU 100.

For this, the power management device 200 may analyze the number of frames processed in the previous time period by counting the number of interrupts inputted to the frame buffer driver 110 of the GPU 100, and manage the loss frame number as an accumulated value as compared to the target frame number.

FIG. 4 is a flow chart to explain a power management method for a graphic processing unit according to an example embodiment of the present invention.

Referring to FIG. 4, the power management method for the graphic processing unit 100 may comprise a step S410 of determining a target frame number representing the number of frames which should be processed for a time period, a step S420 of determining the number of frames processed by the GPU 100 in the previous time period, a step S430 of calculating the loss frame number of the previous time period based on the target frame number and the processed frame number, and a step S440 of adjusting an operating frequency of the GPU 100 based on the loss frame number.

In the step S440, the operating frequency may be adjusted based on the target frame number and the processed frame number. A difference between the target frame number and the processed frame number (i.e. the loss frame number) may be calculated and used for the operating frequency adjustment. The target frame number may be determined in the step S410, and the processed frame number may be determined in the step S420.

In the step S420, the processed frame number may be determined based on the number of interrupts processed in the frame buffer driver of the GPU 100.

Re-referring to FIG. 3, in order to determine the process frame number for each time period, the power management device 200 may analyze the number of frames processed in the previous time period by counting the number of interrupts inputted to the frame buffer driver 110 of the GPU 100, and manage the loss frame number as an accumulated value as compared to the target frame number.

The adjusted operating frequency may be applied to the current time period or the following time period. In the step S440, the operating time frequency may be adjusted by controlling the power management module 310 of the OS 300 so that the processed frame number for the current time period approaches the target frame number.

The operating frequency adjusted based on the loss frame number of the previous time period or the processed frame number may be directly applied to the current time period of the GPU 100. Alternatively, the adjusted operating frequency may be applied to the next time period. For example, if the loss frame number of the previous time period is large, the operating frequency of the current time period may be increased proportionally to the loss frame number. Alternatively, the operating frequency may be adjusted based on a moving average of the loss frame number. Alternatively, the operating frequency may be adjusted by estimating a loss frame number of the current time period or a next time period on the basis of a regression analysis on the loss frame numbers of several previous time periods.

If the loss frame number is larger than a predetermined threshold value, the operating frequency of the current time period may be controlled to be higher than the operating frequency of the previous time period. Also, if the loss frame number is identical to the predetermined threshold value, the operating frequency may be maintained. On the contrary, if the loss frame number is smaller than the predetermined threshold value, the operating frequency of the current time period may be controlled to be lower than the operating frequency of the previous time period.

For example, when the predetermined threshold value is configured to be 0, if the loss frame number of the previous time period is larger than 0, the power management device 200 may control the power management module 310 of the OS 300 to select a higher operating frequency for the GPU 100 than the operating frequency of the previous time period. In this case, a change amount of the operating frequency may be selected according to the processed frame number or the loss frame number of the previous time period.

When the loss frame number of the previous time period is identical to or less than 0, the power management device 200 may control the power management module 310 of the OS 300 to maintain the operating frequency or lower the operating frequency.

If the process frame number of the previous time period is equal to or smaller than a predetermined number and utilization ratios of processor cores of the GPU 100 are lower than a predetermined level, the operating frequency of the previous time period may be adjusted to be a predetermined minimum value.

For example, when the processed frame number of the previous time period is 0 and the utilization ratios of the processor cores of the GPU 100 are lowered below the predetermined level, it can be assumed that no tasks are assigned to the GPU 100. In this case, the power management device 200 may control the power management module 310 of the OS 300 to select the lowest operating frequency so as to reduce power consumption of the GPU 100.

FIG. 5 is a block diagram to explain a graphic processing unit having a power management function according to an example embodiment of the present invention and its components.

Referring to FIG. 5, the graphic processing unit 600 having a power management function may comprise a frame processing information providing part 610 configured to provide information to the power management device 700 on the processed frame number in a time period, an operating frequency information receiving part 620 configured to receive information on operating frequency determined based on the processed frame number, and an operating frequency controlling part 630 configured to adjust the operating frequency by controlling a power management module 510 of an operating system 500 based on the information on operating frequency.

The graphic processing unit 600 according to an example embodiment of the present invention may comprise at least one processor for image processing. Also, the frame processing information providing part 610, the operating frequency information receiving part 620, and the operating frequency controlling part 630 may be implemented as a computer program comprising program codes executed by the at least one processor.

The frame processing information providing part 610 may provide a power management device 700 with the information on the processed frame number, and the operating frequency information receiving part 620 may receive the information operating frequency from the power management device 700. Also, the operating frequency controlling part 630 may control a power management module 510 of the OS 500 to adjust the operating frequency.

The adjusted operating frequency may be applied to the current time period or the following time period. The operating frequency controlling part 630 may adjust the operating frequency based on the loss frame number and a predetermined threshold value.

The operating frequency adjusted based on the loss frame number of the previous time period or the processed frame number of the GPU 600 may be directly applied to the current time period of the GPU 600. Alternatively, the adjusted operating frequency may be applied to the next time period. For example, if the loss frame number of the previous time period is large, the operating frequency of the current time period may be increased proportionally to the loss frame number. Alternatively, the operating frequency may be adjusted based on a moving average of the loss frame number. Alternatively, the operating frequency may be adjusted by estimating a loss frame number of the current time period or a next time period on the basis of a regression analysis on the loss frame numbers of several previous time periods.

Since a method for adjusting the operating frequency based on the loss frame number and the predetermined threshold value is identical to the previously-explained method, redundant explanation will be omitted.

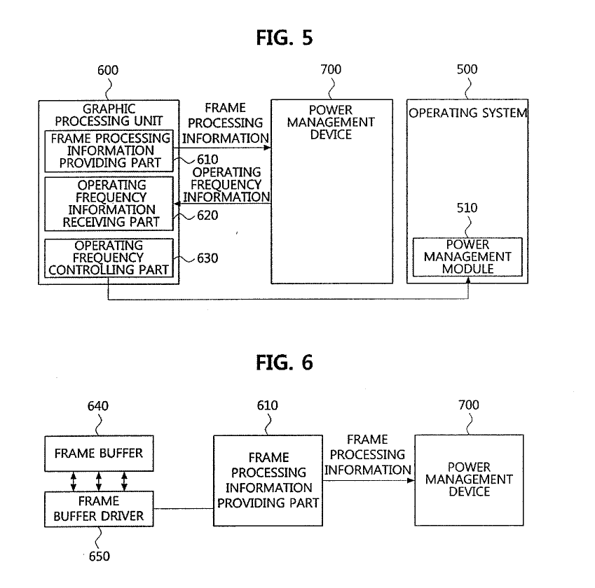

FIG. 6 is a block diagram to explain a method for providing information on a processed frame number based on the number of generated interrupts in a graphic processing unit according to an example embodiment of the present invention.

Referring to FIG. 6, the frame processing information providing part 610 may determine the processed frame number based on the interrupts processed in a frame buffer driver 650 of the GPU 600.

In order to determine the processed frame number, the frame processing information providing part 610 of the GPU 600 may analyze the number of frames processed in the previous time period by counting the number of interrupts inputted to the frame buffer driver 650 of the GPU 600, and manage the loss frame number as an accumulated value as compared to the target frame number.

Although several aspects of the present invention were explained from aspects of apparatuses, it is clear that such the aspects may also be applied to corresponding methods. That is, each step constituting the method may correspond to operations of one or more components constituting the corresponding apparatus. The example embodiments of the present invention may be implemented as program codes or a computer program product having the program codes.

While the example embodiments of the present invention and their advantages have been described in detail, it should be understood that various changes, substitutions and alterations may be made herein without departing from the scope of the invention.

What is claimed is:

1. A power management device performing power management of a graphic processing unit (GPU), the device comprising:
a target frame number determining part configured to determine a target frame number which the GPU is required to process in a time period;
a processed frame number determining part configured to determine a processed frame number processed by the GPU in a previous time period; and
an operating frequency adjusting part configured to calculate a loss frame number based on the target frame number and the processed frame number, and adjust an operating frequency of the GPU based on the loss frame number.

2. The device of the claim 1, wherein the processed frame number determining part determines the processed frame number based on a number of interrupts processed in a frame buffer driver of the GPU.

3. The device of the claim 1, wherein the operating frequency is applied to a current time period or a next time period

4. The device of the claim 1, wherein the operating frequency adjusting part controls a power management module of an operating system (OS) to adjust the operating frequency of the GPU so that a number of frames processed in a current time period approaches the target frame number.

5. The device of the claim 1, wherein, when the loss frame number is larger than a predetermined threshold value, the operating frequency of a current time period is set to a higher value than an operating frequency of the previous time period.

6. The device of the claim 1, wherein, when the loss frame number is equal to a predetermined threshold value, the operating frequency of a current time period is set to a same value with an operating frequency of the previous time period.

7. The device of the claim 1, wherein, when the loss frame number is smaller than a predetermined threshold value, the operating frequency of a current time period is set to a lower value than an operating frequency of the previous time period.

8. The device of the claim 1, wherein, when the processed frame number of the previous time period is smaller than a predetermined number and a utilization ratio of a processor core of the GPU is lower than a predefined level, the operating frequency of a current time period is set to a predefined minimum value.

9. A method for performing power management of a graphic processing unit (GPU), the method comprising:
determining a target frame number which the GPU is required to process in a time period;
determining a processed frame number processed by the GPU in a previous time period; and
calculating a loss frame number of the previous time period based on the target frame number and the processed frame number, and adjusting an operating frequency of the GPU based on the loss frame number.

10. The method of the claim 9, wherein, in the determining the processed frame number, the processed frame number is determined based on a number of interrupts processed in a frame buffer driver of the GPU.

11. The method of the claim 9, wherein the operating frequency is applied to a current time period or a next time period.

12. The method of the claim 9, wherein, in the adjusting the operating frequency of the GPU, the operating frequency is adjusted by controlling a power management module of an operating system (OS) so that a number of frames processed in a current time period approaches the target frame number.

13. The method of the claim 9, wherein, when the loss frame number is larger than a predetermined threshold value, the operating frequency of a current time period is set to a higher value than an operating frequency of the previous time period.

14. The method of the claim 9, wherein, when the loss frame number is equal to a predetermined threshold value, the operating frequency of a current time period is set to a same value with an operating frequency of the previous time period.

15. The method of the claim 9, wherein, when the loss frame number is smaller than a predetermined threshold value, the operating frequency of a current time period is set to a lower value than an operating frequency of the previous time period.

16. The method of the claim 9, wherein, when the processed frame number of the previous time period is smaller than a predetermined number and a utilization ratio of a processor core of the GPU is lower than a predefined level, the operating frequency of a current time period is set to a predefined minimum value.

17. A graphic processing unit having a power management function, the graphic processing unit comprising:
a frame processing information providing part configured to provide information on a processed frame number in a time period;
an operating frequency information receiving part configured to receive information on an operating frequency determined based on the processed frame number; and
an operating frequency controlling part configured to control a power management module of an operating system (OS) based on the information on the operating frequency so as to adjust the operating frequency.

18. The graphic processing unit of the claim 17, wherein the processed frame number is determined based on a number of interrupts processed in a frame buffer driver of is the GPU.

19. The graphic processing unit of the claim 17, wherein the operating frequency is applied to a current time period or a next time period.

20. The graphic processing unit of the claim 17, wherein the operating frequency controlling part controls the operating frequency based on a loss frame number and a predetermined threshold value.
